(19) United States
(12) Patent Application Publication
(10) Pub. No.: US 2005/0069095 A1
(43) Pub. Date: Mar. 31, 2005

(54) Search capabilities for voicemail messages

(75) Inventors: Craig William Fellenstein, Brookfield, CT (US); Carl Phillip Gusler, Austin, TX (US); Rick Allen Hamilton II, Charlottesville, VA (US); James Wesley Seaman, Falls Church, VA (US)

Correspondence Address: Biggers & Ohanian, PLLC, Suite 970, 504 Lavaca, Austin, TX, 78701, US

(73) Assignee: INTERNATIONAL BUSINESS MACHINES CORPORATION, ARMONK, NY (US)

(21) Appl. No.: 10/671,250

(22) Filed: Sep. 25, 2003

(51) Int. Cl. H04M 1/64; H04M 11/00

(52) U.S. Cl. 379/88.02; 379/88.16

(57) ABSTRACT

Methods, systems, and products for voicemail searching that include storing, in association with voicemail messages, voiceprints of callers who leave voicemail messages for voicemail users in a voicemail system; storing caller speech tags in association with the voiceprints; identifying, in dependence upon caller voiceprints, callers who leave new voicemail messages; receiving, from a particular voicemail user, search keywords entered as speech and converted to text through automated speech recognition; and selecting, in dependence upon the search keywords and the caller speech tags, one or more selected voicemail messages from a multiplicity of voicemail messages for the particular voicemail user.

BACKGROUND OF THE INVENTION

1. Field of the Invention

The field of the invention is data processing, or, more specifically, methods, systems, and products for voicemail searching.

2. Description Of Related Art

Busy professionals today rely heavily upon the capabilities of voicemail systems which have become pervasive throughout both professional and person messaging channels. It is not at all uncommon that a business professional may receive dozens of voicemail messages in a single day. Often, throughout the day, that individual may check messages as opportunity arises and save those messages which need to be reviewed again or acted upon later. As a result of this scenario repeating over days and weeks, it can become quite cumbersome sifting through numerous saved messages which might be present in the user's message queues at any given time. It is also difficult for the voicemail system user to prioritize the order in which he or she hears messages, as standard systems prioritize strictly by “urgent and “standard” messages, as specified at the point of call origin. Unfortunately, these caller-defined values often will not correspond to the listeners priorities for message playback. There is therefore an ongoing need for improved methods of voicemail searching.

### SUMMARY OF THE INVENTION

Methods, systems, and products for voicemail searching are disclosed as including storing, in association with voicemail messages, caller voiceprints of callers who leave voicemail messages for voicemail users in a voicemail system; storing caller speech tags in association with the voiceprints; identifying, in dependence upon caller voiceprints, callers who leave new voicemail messages; receiving, from a particular voicemail user, search keywords entered as speech and converted to text through automated speech recognition; and selecting, in dependence upon the search keywords and the caller speech tags, one or more selected voicemail messages from a multiplicity of voicemail messages for the particular voicemail user.

In some embodiments, storing caller voiceprints includes prompting callers for predefined greetings for voiceprints. In other embodiments, storing caller voiceprints includes extracting voiceprints from voicemail. In typical embodiments, storing caller speech tags is carried out by prompting voicemail users to enter caller speech tags for the voiceprints. Prompting voicemail users to enter caller speech tags often includes accepting spoken caller speech tags from voicemail users and converting the spoken caller speech tags to text.

Another method for voicemail searching is disclosed as including storing, in association with voicemail messages, caller identification data that identifies callers who leave voicemail messages for voicemail users in a voicemail system; identifying, in dependence upon the caller identification data, callers who leave new voicemail messages; receiving search keywords from a particular voicemail user; and selecting, in dependence upon the search keywords and the caller identification data, one or more selected voicemail messages from a multiplicity of voicemail messages for the particular voicemail user. A further method for voicemail searching is disclosed as including storing, in association with voicemail messages, message text converted from the voicemail messages; receiving, from a particular voicemail user, search keywords entered as speech and converted to text through automated speech recognition; and selecting, in dependence upon the search keywords and the message text, one or more selected voicemail messages from a multiplicity of voicemail messages for the particular voicemail user.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a network architecture in which various embodiments of the present invention may be implemented.

FIG. 2 sets forth a block diagram of computing machinery useful according to embodiments of the present invention.

FIG. 3 is a database diagram illustrating data structures and relations among data structures useful in various embodiments of the present invention.

FIG. 4 is a flow chart illustrating an exemplary method of voicemail searching according to at least one embodiment of the present invention.

FIG. 5 sets forth a flow chart illustrating a further exemplary method for voicemail searching.

FIG. 6 sets forth a flow chart illustrating a still further exemplary method for voicemail searching.

### DETAILED DESCRIPTION OF EXEMPLARY EMBODIMENTS

### Introduction

Exemplary embodiments are described generally in this specification in terms of methods for voicemail searching. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention. Suitable programming means include, for example, systems comprised of processing units and arithmetic-logic circuits connected to computer memory. Such systems generally have the capability of storing in computer memory programmed steps of methods according to exemplary embodiments for execution by a processing unit. Generally in such systems, computer memory is implemented in many ways as will occur to those of skill in the art, including magnetic media, optical media, and electronic circuits configured to store data and program instructions.

Further, embodiments may be implemented as a computer program product for use with any suitable data processing system. Embodiments of a computer program product may be implemented as a diskette, CD ROM, EEPROM (‘flash’) card, or other magnetic or optical recording media for storage of machine-readable information as will occur to those of skill in that art. Persons skilled in the art will immediately recognize that any computer system having suitable programming means will be capable of executing the steps of methods according to exemplary embodiments as included in a computer program product. Moreover, persons skilled in the art will recognize immediately that, although many of the exemplary embodiments described in this specification are oriented to software installed on computer hardware, nevertheless, alternative embodiments implemented as firmware or other computing machinery are well within the scope of the present invention.

### Voicemail Searching

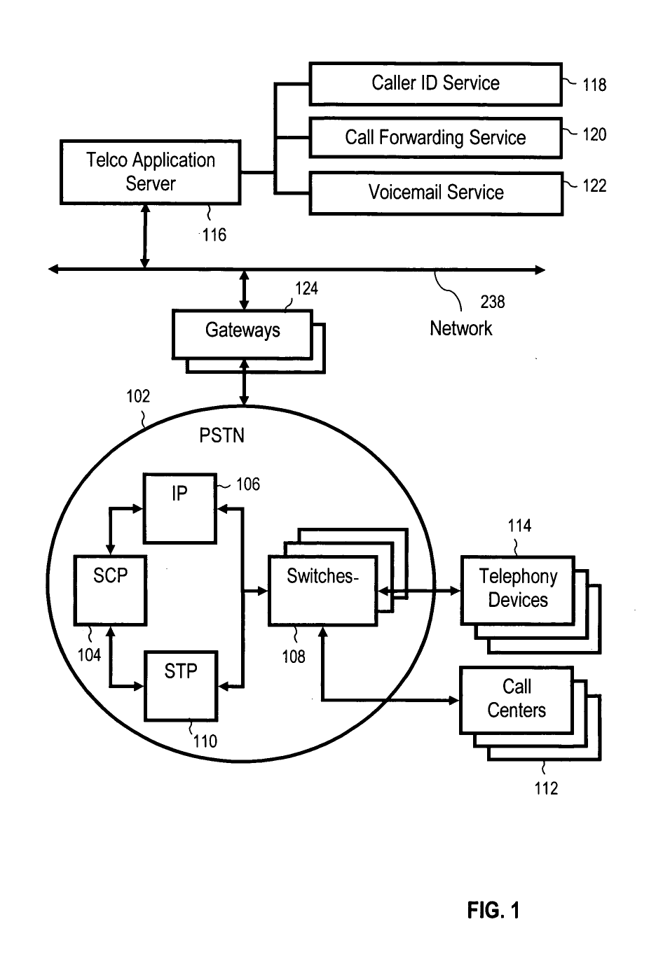

Exemplary methods, systems, and products for voicemail searching now are described with reference to the drawings, beginning with FIG. 1. Typical embodiments of the present invention carry out voicemail searching by storing caller voiceprints in association with voicemail messages. The caller voiceprints are voice samples of callers who leave voicemail messages in a voicemail system for voicemail subscribers (“users”). Methods of voicemail searching according to embodiments of the present invention typically include storing caller speech tags in association with the voiceprints, and identifying callers who leave new voicemail messages in dependence upon the stored caller voiceprints. The speech tags are data elements according to which the voiceprints associated with voicemail messages are identified, sorted, or indexed.

Methods of voicemail searching according to embodiments of the present invention typically include receiving, from a particular voicemail user, search keywords entered as speech and converted to text through automated speech recognition. When such a user provides search keywords for searching for one or more voicemail messages, typical embodiments include selecting for the user's review one or more selected voicemail messages from among all the of voicemail messages recorded for that particular voicemail user. Such a search is carried out by searching for the search keywords among caller speech tags that were previously stored as data elements associated with the voicemail messages in the voicemail system.

FIG. 1 sets forth a block diagram of a network architecture in which various embodiments of the present invention may be implemented. While the present invention is described for purposes of explanation with reference to one type of network architecture, it will be understood by readers of skill in the art that embodiments of the present invention may be implemented in many different network architectures.

The exemplary architecture of FIG. 1 includes Public Switching Telephone Network (“PSTN”) 102. The structure of a PSTN 102 may include multiple telephone networks, each owned by one of multiple independent service providers. Each telephone line is carried by an independent service provider within PSTN 102 and is typically assigned to at least one subscriber. Telephone networks within PSTN 102 may access data networks functioning as extensions to PSTN 102 via an intranet. Data networks may include, for example, subscriber profiles, billing information, and preferences that are utilized by a service provider to specialize services. Each telephone network within a PSTN 102 may access server systems external to PSTN 102 in the Internet Protocol over an internet or an intranet, such as, for example, network 238. Such external server systems may include enterprise servers, servers of Internet Service Providers (“ISPs”), servers of Access Service Providers (“ASPs”), personal computers, and other computing systems accessible via a network as will occur to those of skill in the art.

In the present example, network 238 may comprise a private network, intranet, or a public Internet Protocol network, such as, for example, the Internet. PSTN 102 is connected for data communications to network 238. Available data communications includes both voice and data signals coupled to network 238 through one or more gateways (not shown). Each gateway acts as a switch between PSTN 102 and network 238 that may compress signals, convert signals into the message form of the Internet Protocol, SIP, or other protocol packets, and routes packets through network 238 to a destination server. SIP in particular is a signaling protocol for Internet conferencing, telephony, presence, events notification and instant messaging. The gateways 124 may include Parlay gateways and SS7 gateways. Internet servers, such as telco application server 116 may include protocol agents that are enabled to interact with multiple protocols encapsulated in Internet Protocol packets including, for example, SS7, Parlay, and SIP.

±SS7” is the Common Channeling Signaling System No. 7, a global standard for telecommunications defined by the International Telecommunication Union (“ITU”). The SS7 standard defines the procedures and protocol by which network elements in the PSTN exchange information over a digital signaling network to effect wireless and wireline call setup, routing, and control. SS7 messages are exchanged between network elements over bidirectional channels called ‘signaling links.’ Signaling occur ‘out-of-band’ on dedicated channels rather than in-band on voice channels. SS7 network signaling points are uniquely identified by a numeric point code. Signaling points in SS7 networks include Service Switching Points (“SSPs”), Signal Transfer Points (“STPs”), and Service Control Points (“SCPs”). “Parlay” refers to an open-systems API for telco applications developed by the Parlay Group, an industry consortium that includes IBM, Microsoft, British Telecom, Nortel Networks, Siemens, AT&T, Cisco, Lucent, Ericsson, and others. “SIP” stands for Session Initial Protocol, a signaling protocol for Internet conferencing, telephony, presence, events notification and instant messaging. SIP supports call setup, routing, caller identification, and other features between endpoints in an Internet Protocol domain. Telco application server 116 is an example of a server systems external to PSTN 102 that may be accessed by PSTN 102 over network 238. In particular, telco application server 116 includes multiple telco specific service applications 118, 120, 122 for providing services to calls transferred to a server external to PSTN 102. Examples of telco specific services that may be provisioned through an external telco application server such as server 116 include a caller ID server 118, a call forwarding server 120, a voicemail server 122, and others as will occur to those of skill in the art. Calls may be transferred from PSTN 102 to telco application server 116 to receive at least one service after which the calls are transferred back to PSTN 102. Such services may also be provided to calls from within PSTN 102. Providing such services from a third party location such as telco application server 116 is advantageous, however, because adding services and information to PSTN 102 is time consuming and costly when compared with the time and cost of adding the services through telco application server 116.

Telco application server 116, or other servers as will occur to those of skill in the art, in addition to telco related services, may also provide messaging services, financial services, database management services, and others as will occur to those of skill in the art. Such service may be accessed by subscribers and other users in the HyperText Transport Protocol (“HTTP”) via network 238. Telco application server 116 may also support subscriber profiles as well as services for managing and updating subscriber profiles.

A caller may be identified by one of the telephony devices 114, by the PSTN itself 102, by telco application server 116. By identifying a caller as such, rather than merely identifying a device from which a call is made, an enhanced specialization of services to subscribers may be performed, particularly in the use of voicemail searching according to embodiments of the present invention.

A voicemail service 122 of telco application server 116 may include identification of a caller for a particular voicemail message. Such a service may require that callers provide voiceprints when leaving voicemail messages. Alternatively, the service may extract voiceprints from voicemail messages. Stored voiceprints may then be compared against subsequent voicemail messages to identify a caller who leaves a new voicemail message.

A PSTN 102 typically includes multiple central office switches 108 that originate and terminate calls. Central office switches 108 query service control points (“SCPs”) 104 to determine how to route calls. SCPs 104 send responses to central office switches containing routing numbers associated with a dialed number for a call. SCPs 104 may be general purpose computers storing databases of call processing information. While in the present example, SCPs 104 are depicted locally within PSTN 102, in other embodiments, SCPs 104 may be part of an extended network accessible to PSTN 102 via a network.

One of the functions performed by SCPs 104 is processing calls to and from various subscribers. For example, an SCP may store in a subscriber profile or a user profile a record of services purchased by a subscriber or user, such as a voicemail service. When a call is made to the subscriber or user, the SCP may provide a record of the voicemail service to support a request for a caller to identify provide a voiceprint.

In particular, network traffic between signaling points may be routed via a packet switch called an service transfer point (“STP”) 110. STP 110 routes each incoming message to an outgoing signaling link based on routing information. The signaling network may typically utilize an SS7 network implementing SS7 protocol.

Central office switches 108 may also send voice and signaling messages to intelligent peripherals (“IPs”) 106 via voice trunks and signaling channels. IP 106 provides enhanced announcements, enhanced digit collection, and enhanced speech recognition capabilities.

In typical embodiments of the present invention, a caller is identified according to voice recognition. Voice recognition is preferably performed by first identifying a caller by matching a voiceprint with a portion of a voicemail message. Voiceprints may be stored on and provisioned from local IPs 106, remote IPs accessed across a network, telephony devices 114, a telco application server 116, a voicemail server 122, or other repositories for voiceprints as will occur to those of skill in the art. In alternate embodiments, a caller may be identified according to caller identification information such as a telephone number or a caller's name provided by a caller ID service.

Telephony devices 114 may include, for example, wireless devices, pervasive devices equipped with telephony features, a network computer, a facsimile, a modem, PDAs, wireless telephones, other handheld wireless devices, and other devices enabled for network communication as will occur to those of skill in the art. Caller voice recognition functionality may advantageously be included in any telephony device 114.

Telephony devices are connected for communications to PSTN 102 via wireline, wireless, optical, ISDN, and other communication links. Connections to telephony devices 114 typically provide digital transport for two-way voice grade type telephone communications and a channel transporting signaling data messages in both directions between telephony devices 114 and PSTN 102. In addition to telephony devices 114, advanced telephone systems, such as call centers 112, may be connected for communications to PSTN 102 via wireline, wireless, optical, ISDN and other communication links. Call centers 112 may include PBX systems, hold queue systems, private network systems, and other systems that are implemented to handle distribution of calls to multiple representatives or agents.

In a typical PSTN 102, one central office switch 108 serves each exchange or area served by the NXX digits of an NXX-XXXX (seven digit) telephone number or the three digits following the area code digits (the Numbering Plan Area code or “NPA”) in a ten-digit telephone number. A service provider owning a central office switch also assigns a telephone number to each line connected to each of central office switches 108. The assigned telephone number includes the area code (NPA) and exchange code (NXX) for the serving central office and four unique digits (XXXX).

Central office switches 108 in such PSTNs typically utilize office equipment (“OE”) numbers to identify specific equipment, such as physical links or circuit connections. For example, a subscriber's line might terminate on a pair of terminals on a main distribution frame of a central office switches 108. The switch identifies the terminals, and therefore a particular line, by an OE number assigned to that terminal pair. A service provider may assign different telephone numbers to the one line at the same or different times. For example, a local carrier may change the telephone number because a subscriber sells a house and a new subscriber moves in and receives a new number. The OE number for the terminals and thus the line itself, however, remains the same.

On a normal call, a central office switch will detect an off-hook condition on a line and provide a dial tone. The switch identifies the line by the OE number. The central office switch retrieves subscriber or user profile information corresponding to the OE number and off-hook line. The central office switch then receives the dialed digits from the off-hook line terminal and routes the call. The central office switch may route the call over trunks and possibly through one or more central office switches to the central office switch that serves the callee's station or line. The switch terminating a call to a destination will also utilize profile information relating to the destination, for example, to forward the call if appropriate, to apply distinctive ringing, and to provide other services oriented to the callee.

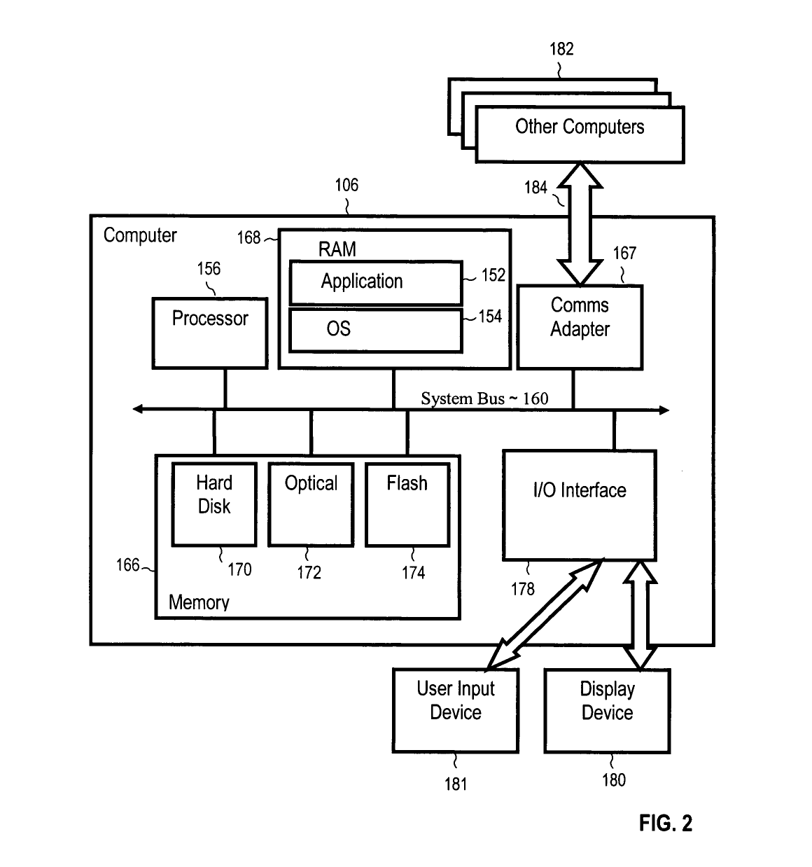

FIG. 2 sets forth a block diagram of computing machinery that includes a computer 106, useful, for example, as a telco server, an intelligent peripheral, or a telephony device according to embodiments of the present invention. The computer 106 of FIG. 2 includes at least one computer processor 156 or ‘CPU’ as well as random access memory 168 (“RAM”). Stored in RAM 168 is an application program 152. Application programs typically include software designed an implemented to carry out method steps according to embodiments of the present invention. Also stored in RAM 168 is an operating system 154. Operating systems useful in computers according to embodiments of the present invention include AIX™, Linux, Microsoft NT™, and many others as will occur to those of skill in the art.

The computer 106 of FIG. 2 includes computer memory 166 connected through a system bus 160 to the processor 156 and to other components of the computer. Computer memory 166 may be implemented as a hard disk drive 170, optical disk drive 172, electrically erasable programmable read-only memory space (‘EEPROM’ or ‘Flash’ memory) 174, RAM drives (not shown), or as any other kind of computer memory as will occur to those of skill in the art.

The example computer 106 of FIG. 2 includes communications adapter 167 implementing data communications connections 184 to other computers 182, servers, clients, telephony devices, or networks. Communications adapters implement the hardware level of data communications connections through which computers and servers send data and voice communications directly to one another and through networks. Examples of communications adapters include modems for wired dial-up connections, Ethernet (IEEE 802.3) adapters for wired LAN connections, and 802.11b adapters for wireless LAN connections.

The example computer of FIG. 2 includes one or more input/output interface adapters 178. Input/output interface adapters in computers implement user-oriented input/output through, for example, software drivers and computer hardware for controlling output to display devices 180 such as computer display screens, as well as user input from user input devices 181 such as keyboards and mice.

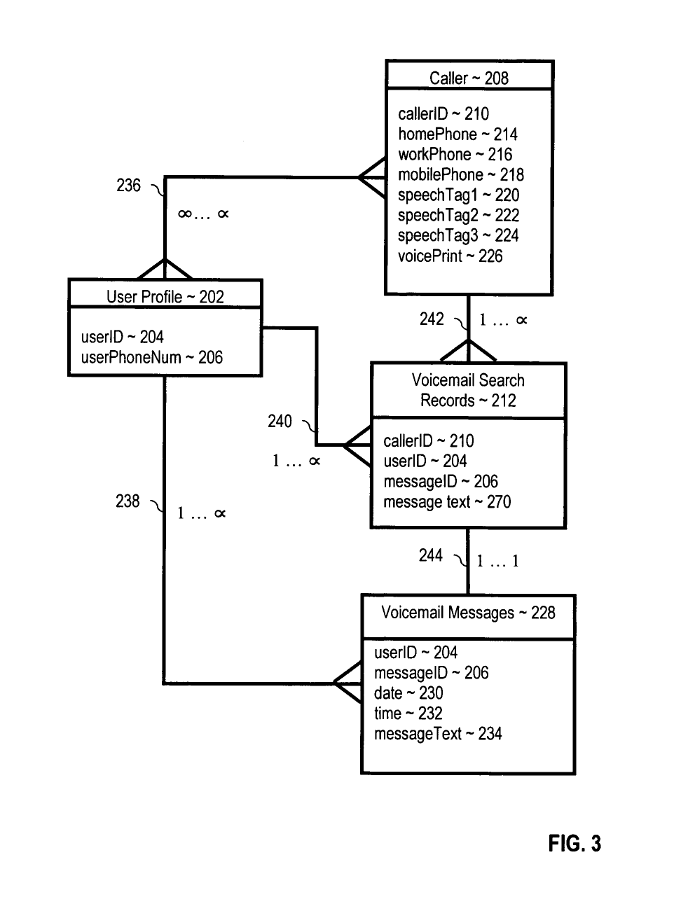

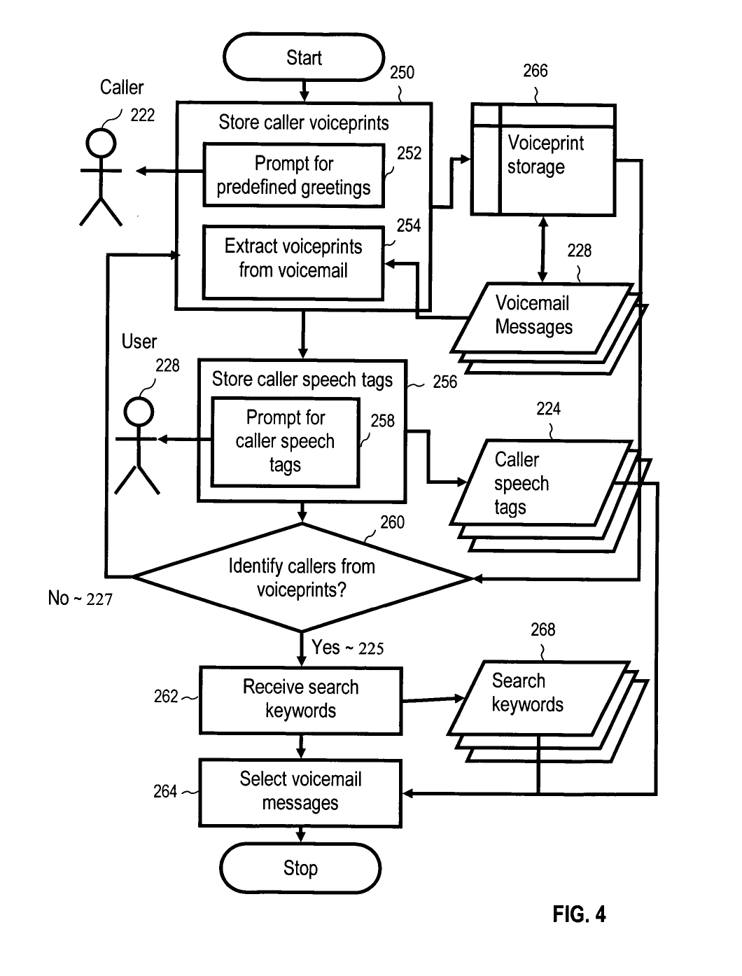

Exemplary methods and systems for voicemail searching are further explained with reference to FIGS. 3 and 4. FIG. 3 is a database diagram illustrating data structures and relations among data structures useful in various embodiments of the present invention. FIG. 4 is a flow chart illustrating an exemplary method of voicemail searching according to at least one embodiment of the present invention.

The method of FIG. 4 includes storing (250), in association with voicemail messages (228), caller voiceprints of callers who leave voicemail messages for voicemail users in a voicemail system. A voicemail system may be a voicemail service such as the example at reference 122 on FIG. 1. A voicemail system may be provisioned to a PSTN through an external telco application server 116, through one or more intelligent peripherals 106 within a PSTN 102, or through telephony devices 114.

Caller voiceprints may be acquired for storage by prompting (252 on FIG. 4) callers for predefined greetings for voiceprints. Alternatively, voiceprints may be acquired for storage by extracting (254) voiceprints from voicemail messages (228). Caller voiceprints may be stored in association with voicemail messages by use of data structures such as those shown as examples in FIG. 3. The exemplary data structures of FIG. 3 include user profile records 202, each of which represents and contains.data elements describing a callee subscriber to a voicemail service. The ‘user’ is a callee subscriber to a voicemail service, a subscriber for whom callers leave voicemail messages. For clarity in this specification, such callee subscribers are generally referred to simply as ‘users.’ Data elements in the user profile include a user identification ‘userID’ 204, a unique key, typically system-generated. In this example, the user profile also includes a telephone number of the user 206. Although not shown here, the user profiles may contain also such other descriptive elements as will occur to those of skill in the art.

The exemplary data structures of FIG. 3 include a caller table 208 in which each record represents a caller who leaves one or more voicemail messages to a user of a voicemail system. The caller records 208 include a single-field unique identification key ‘callerID’ 210, typically system-assigned. The caller records 208 also include caller identification data such as home telephone number 214, work telephone number 216, mobile telephone number 218, and so on, as will occur to those of skill in the art. The caller records 208 also contain one or more speech tags, 220, 222, 224. Three speech tags are shown, for explanation, not for limitation. In fact, any number of speech tags may be assigned to a caller record. Users of skill in the art will recognize that such speech tags may advantageously be represented in separate speech tag records keyed to the caller records with callerID as a foreign key. They are shown in the caller records here for clarity, not for limitation.

The caller records 208 in the exemplary structures of FIG. 3 also each contains at least one voiceprint 226. The voiceprints 226 are binary data, and as such may preferably be stored as BLOBs. A “BLOB” is a “Binary Large OBject,” a collection of binary data stored as a single entity in a database. BLOBs are used to hold multimedia content such as video and, of particular interest, audio clips, although they are also used to store software, even executable binary code. Not all databases support BLOBs, however. In some installations, therefore, the voiceprint data elements 226 in caller records 208 may contain a pathname or other pointer to a file system location at which is stored an actual audio clip containing a voiceprint of a caller.

The caller records 208 are related many-to-many 236 to the user profile records 202. The relationship 236 is not literal, of course, because the user profile records 202 in this example contain no callerID fields 210, and the caller records 208 contain no userid fields 204. The relationship instead is implemented by using the voicemail search records 212 as a linking table between the user profiles 202 and the caller records 208, thereby implementing a many-to-many relationship in which one user may have voicemail messages from many callers and one caller may leave voicemail messages for many users. Each voicemail search record 212 represents one voicemail message from one caller for one user. This is represented in the exemplary data structures by the one-to-one relationship 244 between the voicemail search records 212 and the voicemail messages 228, the one-to-one relationship being implemented by use of messageld 206 as a foreign key.

The exemplary data structure of FIG. 3 also illustrate a one-to-many relationship 238 between users 202 and voicemail messages 228. This is true because the destination telephone number is typically provided from a PSTN to whatever network host implements the voicemail message system, internally or externally to the PSTN. Caller identification systems, however, such as the one illustrated at reference 118 on FIG. 1, typically identify only the subscriber name and telephone number for the telephony device from which a call originates, thereby failing to identify callers who are not the subscriber identified with that particular telephony device.

As an aid to identifying a particular caller, the method of FIG. 4 includes storing (256) caller speech tags (224) in association with the voiceprints. Storing (256) caller speech tags may be carried out by prompting (258) voicemail users to enter caller speech tags for the voiceprints. Prompting (256) voicemail users to enter caller speech tags may include accepting spoken caller speech tags from voicemail users and converting the spoken caller speech tags to text. That is, typically in the method according to FIG. 4, caller speech tags comprise text generated through automated speech recognition of voicemail users' voices.

The method of FIG. 4 also includes identifying (260), in dependence upon caller voiceprints, callers who leave new voicemail messages. Identifying callers is typically carried out by comparing a voice sample from a new voicemail message with previously-stored voiceprints. This process is voice recognition as distinguished from speech recognition. Speech recognition, as the term is used in this specification, is the generation of text from speech or audio. Voice recognition is the comparison of binary audio representations to identify matches. If a match is found 225, processing continues for voicemail searching. If a match is not found 227, indicating a new caller, one who has not previously left a voicemail message in this voicemail system, a new caller voiceprint is stored 250 for use in identifying the new caller, and new caller speech tags are stored 256 for the new voiceprint.

In terms of the exemplary data structures of FIG. 3, the fact that a match is found between the voice of a current caller and a voiceprint is represented by the creation of a voicemail search record 212 containing a callerID 210 for the identified caller identified by the voiceprint match, a userID 204 for the user for whom a voicemail message is left, and a messageID 206 identifying the voicemail message. Processing may be similar for the case when a match is not found. That is, processing may continue with creation of a new caller record 208 and a new voicemail search record having a userID 204 identifying the user for whom the new email message was left, a messageld 206 identifying the new email message, and a callerID 210 identifying the new caller record. The new caller record is created in this circumstance with a voiceprint (prompted for or extracted from the new voicemail message) but with empty speech tags 220, 222, 224, signifying that a new voicemail message has been received but the caller cannot be identified from existing voiceprints. When a user having voicemail messages from such unidentified callers next checks voicemail, the voicemail system may scan for caller records having no speech tags and prompt the user to enter speech tags for the new caller.

It is typical usage for a user to contact the voicemail system and request a search for one or more of the user's voicemail messages. The method of FIG. 4, therefore includes receiving (262), from a particular voicemail user, search keywords (268) entered as speech and converted to text through automated speech recognition. The speech tags typically are stored as text, and it is the speech tags that support searching.

Searching among text speech tags is advantageously carried out with search keywords encoded also as text. The method of FIG. 4 advantageously therefore also includes selecting (264), in dependence upon the search keywords (268) and the caller speech tags (224), one or more selected voicemail messages from a multiplicity of voicemail messages for the particular voicemail user. This selecting is carried out in dependence upon the search keywords (268) and caller speech tags (224) in the sense that a database search is conducted among caller records, such as the caller records illustrated as an example at reference 208 in FIG. 3, for speech tags matching search keywords.

Advantageously, in typical embodiments of voicemail searching according to the present invention, also illustrated by reference to the example data structures of FIG. 3, such a search may be limited to the caller records 208 of callers known to have left messages in the past for a particular user. The fact that a caller has left voicemail previously for the user is represented in the data structures of FIG. 3 by the existence of a voicemail search record 212 bearing the user identification 204 for the user who owns a particular voice mailbox and the caller identification 210 for callers who previously left voicemail messages for that user.

Methods, systems, and products for voicemail searching with speech tags associated with voiceprints are further explained through the following use case: Voice samples are taken from participating callers and are stored as voiceprints in association with a user's profile along with an associated user-generated speech tag. More particularly: A caller enters a users voicemail system. The caller enters the voicemail system because, for example, the callee user's line is busy or the callee user does not answer the telephone. The caller selects new option to “work with voice commands” and then selects submenu “register voice signature.” Outside caller is prompted to provide a standard greeting such as “Hello, this is John Doe.” A voiceprint is recorded and stored with a marker indicating user action is required. In the example data structures of FIG. 4, a marking indicating user action is implemented as a blank speech tag. Other markers may be used as will occur to those of skill in the art.

The callee user enters the voicemail system to check his or her messages. The user is prompted by the voicemail system: “You have new voice signatures, press 8 to work with markers or press 1 to continue.” The user presses the 8 key and enters a “work with speech commands” module in the voicemail system. The user selects a submenu option to “work with new voice signatures.” The voicemail system plays back for the user the marked voiceprint, “Hello, this is John Doe.” The user selects a submenu option to “create a speech tag” for this signature. The user speaks a speech tag for this voiceprint, such as, for example, “John Doe.” The voicemail system converts the speech tag to text, stores and indexes it in association with the voiceprint and the user's profile data.

In an alternative implementation, the registration of voice commands is transparent to the outside user. In this case, the association of the voiceprint with the particular caller, for indexing of voicemail, is accomplished by the user, where the user (and not the caller) is tasked with associating the caller voice tags obtained by the system with a particular user.

When a call is received, the voicemail system will attempt to match the caller's voice with existing voiceprints. If a match is found, a new voicemail message is indexed to the associated speech tag. Consider the following new voicemail message, for example:
“Hi, this is John. I need to talk to you about the meeting tomorrow. Please give me a call back as soon as you can. Talk to you later.”

In the case where a speech tag has already been created for caller John, the phone mail system would index this incoming call to the associated speech tag, which in many cases is the caller's name, “John Doe.” This speech tag would then be used in searching for voicemail messages from John.

If no match is found, that is, John Doe has not previously recorded a voiceprint, the voicemail system may record a sample of the caller's voiceprint, preferably extracted from the new voicemail message, of sufficient length to be useful in identifying the caller, thereby probably capturing the caller's name and the caller's usual method of greeting, and would store it as a new voiceprint. When a user then accesses the voicemail system to listen to messages, the user would be presented with the new voiceprint and provided the opportunity to assign a speech tag as described above. If the listener assigns a speech tag, it is associated with and indexed to the new voiceprint.

Continuing the use case: A new caller leaves a message, and the voicemail system attempts to recognize the caller's voice. The voicemail system then takes action in dependence upon whether it can find a match for the new caller's voice in an existing voiceprint: if it can, then the new voicemail message is indexed to speech tags for the caller; otherwise, the voicemail system records and marks a new voiceprint.

The callee user later calls in to the voicemail system to hear new (or old) messages. After the system greeting, the user chooses to “search messages through speech commands.” The user provides a speech tag (a name or other search keyword) to for the voicemail system to use in searching for messages, new, old, or both. The voicemail system provides the user provided with message information from messages found by the search keywords or returns the user to the primary voicemail menu if no matches are found. The user is returned to the legacy top level voicemail menu for additional actions.

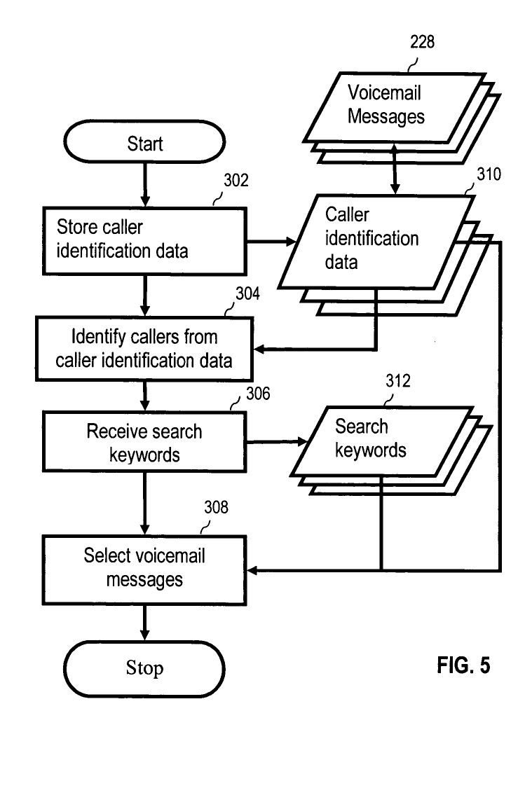

According to a further advantage of the present invention, voicemail searching may be carried out on the basis of caller identification data in addition to, or instead of, speech tags. FIG. 5 sets forth a flow chart illustrating a further exemplary method for voicemail searching that includes storing (302), in association with voicemail messages (228), caller identification data (310) that identifies callers who leave voicemail messages for voicemail users in a voicemail system. In terms of the exemplary data structures of FIG. 3, caller identification data may be represented by data elements in the caller records 208, including, for example, a caller's home telephone number 214, a caller's work telephone number 216, a caller's mobile telephone number 218, and other identification data as will occur to those of skill in the art.

The method of FIG. 5 also includes identifying (304), in dependence upon the caller identification data, callers who leave new voicemail messages. Such caller identification data may be provisioned by, for example, a caller ID service such as that shown at reference 118 on FIG. 1. Such caller ID services typically provide the telephone number of a telephony device from which a particular call is placed. To the extent that such a telephone number is represented in caller identification data in a caller record such as those shown at 208 on FIG. 3, matching a telephone number of a telephony device provided by a caller ID service with such caller identification data may identify the caller.

As mentioned above, it is typical usage for a user to contact the voicemail system and request a search for one or more of the user's voicemail messages. The method of FIG. 5 includes receiving (306), from a particular voicemail user, search keywords (312) entered as speech and converted to text through automated speech recognition. Alternatively, search keywords can be entered through a keyboard, a keypad, or through other means as will occur to those of skill in the art. Caller identification data may be stored as text, and in this kind of embodiment, it is the caller identification data that supports searching. Searching caller identification data in the form of text is advantageously carried out with search keywords encoded also as text. The method of FIG. 5 advantageously therefore also includes selecting (308), in dependence upon the search keywords (312) and the caller identification data (310), one or more selected voicemail messages from a multiplicity of voicemail messages for the particular voicemail user. This selecting typically is carried out in dependence upon the search keywords (312) and caller identification data (310) in the sense that a database search is conducted among caller records, such as the caller records illustrated as an example at reference 208 in FIG. 3, for caller identification data matching search keywords.

Methods, systems, and products for voicemail searching with voice recognition and caller identification data are further explained through the following use case in which a user establishes a caller description or caller record for an expected caller. More particularly: A user enters a voicemail system and selects a menu option for “work with speech tags.” The user selects submenu “add new caller record.” The user selects further submenu “add caller identification data.” Using speech, keypad, or keyboard, the user enters a new caller name and phone numbers to associate with this caller, work number, mobile number, and so on. The user creates one or more speech tags to associate with the newly created caller record.

Later, the caller represented by the new caller record leaves a message, and the voicemail system identifies the caller via the stored caller identification data. The voicemail system takes appropriate action on a new message from the caller, such as marking it searchable by speech commands. In the case of a new voicemail message from a caller for whom no caller record or caller identification data has been established, the voicemail system, not being able to identify such a new caller in the absence of a caller record, may mark a new voicemail message as a candidate for user action and then prompt the user at next log-in to enter caller identification data for the new caller.

The callee user calls in to the voicemail system to hear new (or old) messages. After the system greeting, the user chooses to search messages through speech commands. The user provides a name or other search keyword to the voicemail system to search messages. The user is provided with message information meeting given the search keywords or is returned to the legacy phone mail menu if no matches are found.

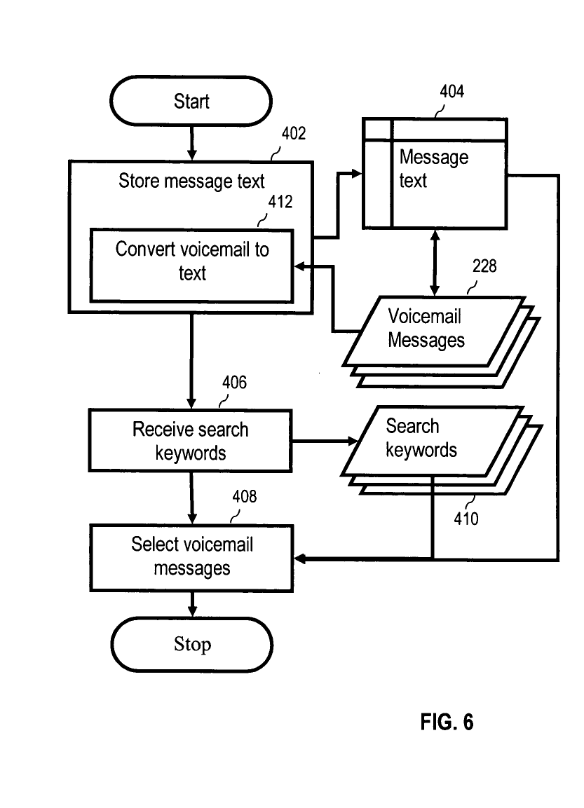

In addition to searches on the basis of speech tags and caller identification data, exemplary embodiments of the present invention also advantageously may support voicemail searching on the basis of text converted from voicemail messages. FIG. 6 sets forth a flow chart illustrating a still further exemplary method for voicemail searching that includes storing (402), in association with voicemail messages (228), message text (404) converted from the voicemail messages. Storing message text in association with voicemail messages may be carried out, as shown for example in the data structures of FIG. 3, by storing message text 270 in voicemail search records 212 having a one-to-one relation with the voicemail messages 228 from which the message text was derived.

The method of FIG. 6 also includes receiving (406), from a particular voicemail user, search keywords (410) entered as speech and converted to text through automated speech recognition, although as an alternative, search keywords can be entered through a keyboard, a keypad, or through other means as will occur to those of skill in the art.

The method of FIG. 6 also includes selecting (408), in dependence upon the search keywords (410) and the message text (404), one or more selected voicemail messages from a multiplicity of voicemail messages for the particular voicemail user. This selecting typically is carried out in dependence upon the search keywords (410) and message text (404) in that a database search is conducted among voicemail search records, such as the voicemail search records illustrated as an example at reference 212 in FIG. 3, for message text data matching search keywords.

Methods, systems, and products for voicemail searching with speech recognition and converted message text are further explained through the following use case: A caller leaves a voicemail message. The voicemail system converts the voicemail message to text, applies filter rules, and stores the message text.

Search rules or filter rules may be included in a profile based on specific text search keywords. A more particular example is: A user logs on to the mail system. The user selects a menu option “work with speech commands.” The user selects submenu “create/edit text conversion rules.” The user specifies, via speech or keypad entries, words to be included or excluded from speech to text conversion. The user saves choices and exits menu.

The user subsequently calls in to the voicemail system to review messages. After the system greeting, the user chooses to “search messages through speech commands.” The user provides a name or other search keywords to the voicemail system to search messages. For example, when prompted the user may say “meeting and John,” where the word “and” is preferably removed via the filter rules. So the result is a search of all messages having the words “meeting” and “john.” The user's search keywords are converted to text and compared to stored message text converted from voicemail messages. The user is provided with message information meeting the search keywords or is returned to the primary voicemail menu if no matches are found.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for voicemail searching, the method comprising:
storing, in association with a voicemail message, a voiceprint of a caller;
storing at least one caller speech tag in association with the voiceprint;
identifying, in dependence upon the voiceprint, a caller who leaves a voicemail message;
receiving, from a particular voicemail user, at least one search keyword; and
selecting, in dependence upon the search keyword and the caller speech tag, one or more voicemail messages for the particular voicemail user.

2. The method of claim 1 wherein storing a voiceprint further comprises prompting a caller for a predefined greeting for the voiceprint.

3. The method of claim 1 wherein storing a voiceprint further comprises extracting the voiceprint from voicemail.

4. The method of claim 1 wherein storing a caller speech tag further comprises prompting a voicemail user to enter a caller speech tag for the voiceprint.

5. The method of claim 4 wherein prompting a voicemail user to enter a caller speech tag comprises:
accepting at least one spoken caller speech tag from the voicemail user; and
converting the spoken caller speech tag to text.

6. A method for voicemail searching, the method comprising:
storing, in association with a voicemail message, caller identification data that identifies a caller;
identifying, in dependence upon the caller identification data, a caller who leaves a new voicemail message;
receiving at least one search keyword from a particular voicemail user; and
selecting, in dependence upon the search keyword and the caller identification data, one or more voicemail messages for the particular voicemail user.

7. A method for voicemail searching, the method comprising:
storing, in association with a voicemail message, message text converted from the voicemail message;
receiving, from a particular voicemail user, at least one search keyword; and
selecting, in dependence upon the search keywords and the message text, one or more voicemail messages for the particular voicemail user.

8. A system for voicemail searching, the system comprising:
means for storing, in association with a voicemail message, a voiceprint of a caller;
means for storing at least one caller speech tag in association with the voiceprint;
means for identifying, in dependence upon the voiceprint, a caller who leaves a voicemail message;
means for receiving, from a particular voicemail user, at least one search keyword; and
means for selecting, in dependence upon the search keyword and the caller speech tag, one or more voicemail messages for the particular voicemail user.

9. The system of claim 8 wherein means for storing a voiceprint further comprises means for prompting a caller for a predefined greeting for the voiceprint.

10. The system of claim 8 wherein means for storing a voiceprint further comprises means for extracting the voiceprint from voicemail.

11. The system of claim 8 wherein means for storing a caller speech tag further comprises means for prompting a voicemail user to enter a caller speech tag for the voiceprint.

12. The system of claim 11 wherein means for prompting a voicemail user to enter a caller speech tag comprises:
means for accepting at least one spoken caller speech tag from the voicemail user; and
means for converting the spoken caller speech tag to text.

13. A system for voicemail searching, the system comprising:
means for storing, in association with a voicemail message, caller identification data that identifies a caller;
means for identifying, in dependence upon the caller identification data, a caller who leaves a new voicemail message;
means for receiving at least one search keyword from a particular voicemail user; and
means for selecting, in dependence upon the search keyword and the caller identification data, one or more voicemail messages for the particular voicemail user.

14. A system for voicemail searching, the system comprising:
means for storing, in association with a voicemail message, message text converted from the voicemail message;
means for receiving, from a particular voicemail user, at least one search keyword; and
means for selecting, in dependence upon the search keywords and the message text, one or more voicemail messages for the particular voicemail user.

15. A computer program product for voicemail searching, the computer program product comprising:
a recording medium;
means, recorded on the recording medium, for storing, in association with a voicemail message, a voiceprint of a caller;
means, recorded on the recording medium, for storing at least one caller speech tag in association with the voiceprint;
means, recorded on the recording medium, for identifying, in dependence upon the voiceprint, a caller who leaves a voicemail message;
means, recorded on the recording medium, for receiving, from a particular voicemail user, at least one search keyword; and
means, recorded on the recording medium, for selecting, in dependence upon the search keyword and the caller speech tag, one or more voicemail messages for the particular voicemail user.

16. The computer program product of claim 15 wherein means for storing a voiceprint further comprises means, recorded on the recording medium, for prompting a caller for a predefined greeting for the voiceprint.

17. The computer program product of claim 15 wherein means for storing a voiceprint further comprises means, recorded on the recording medium, for extracting the voiceprint from voicemail.

18. The computer program product of claim 15 wherein means for storing a caller speech tag further comprises means, recorded on the recording medium, for prompting a voicemail user to enter a caller speech tag for the voiceprint.

19. A computer program product for voicemail searching, the computer program product comprising:
a recording medium;
means, recorded on the recording medium, for storing, in association with a voicemail message, caller identification data that identifies a caller;
means, recorded on the recording medium, for identifying, in dependence upon the caller identification data, a caller who leaves a new voicemail message;
means, recorded on the recording medium, for receiving at least one search keyword from a particular voicemail user; and
means, recorded on the recording medium, for selecting, in dependence upon the search keyword and the caller identification data, one or more voicemail messages for the particular voicemail user.

20. A computer program product for voicemail searching, the computer program product comprising:
a recording medium;
means, recorded on the recording medium, for storing, in association with a voicemail message, message text converted from the voicemail message;
means, recorded on the recording medium, for receiving, from a particular voicemail user, at least one search keyword; and
means, recorded on the recording medium, for selecting, in dependence upon the search keywords and the message text, one or more voicemail messages for the particular voicemail user.
